(19) United States
(12) Patent Application Publication
(10) Pub. No.: US 2013/0079974 A1
(43) Pub. Date: Mar. 28, 2013

(54) OUTRIGGER MONITORING SYSTEM AND METHODS

(71) Applicant: Manitowoc Crane Companies, LLC, Manitowoc, WI (US)

(72) Inventor: Michael W. Stake, Chambersburg, PA (US)

(73) Assignee: Manitowoc Crane Companies, LLC, Manitowoc, WI (US)

(21) Appl. No.: 13/623,752

(22) Filed: Sep. 20, 2012

Related U.S. Application Data
(60) Provisional application No. 61/538,657, filed on Sep. 23, 2011.

(51) Int. Cl. G06F 11/30; G01D 18/00

(52) U.S. Cl. 701/32.9; 701/34.4; 701/33.1

(57) ABSTRACT

An outrigger monitoring system and methods having a graphical user interface. A sensor measures a length of an outrigger and the outrigger monitoring system determines crane fulcrum data based on the length. The system locks the user from continuing if the outriggers are not in a valid operating position. If the user overrides the outrigger monitoring system the crane fulcrum data is then logged and the operator is allowed to continue. In some embodiments the outrigger monitoring system includes a graphical user interface for calibrating the outriggers.

### REFERENCE TO EARLIER FILED APPLICATION

The present application claims the benefit of the filing date under 35 U.S.C. §119(e) of Provisional U.S. Patent Application Ser. No. 61/538,657, filed Sep. 23, 2011, which is hereby incorporated by reference in its entirety.

The present application relates to the field of outriggers for a mobile crane, and more particularly to systems and methods for monitoring the status of the crane outriggers and correlating the status to a crane safety state.

### BACKGROUND

Heavy construction equipment, such as a mobile crane, typically includes a carrier unit in the form of a transport chassis and a superstructure unit having an extendable boom. The superstructure unit is typically rotatable upon the carrier unit. In transport the crane is supported by the carrier unit on its axles and tires.

When used for lifting operations the crane should normally be stabilized to a greater degree than is possible while resting on the tires and axles of the transport chassis. In order to provide stability and support of the crane during lifting operations, it is well known to provide the carrier unit with an outrigger system. An outrigger system will normally include at least two (often four or more) telescoping outrigger beams with inverted jacks for supporting the crane when the crane is located in a position at which it will perform lifting tasks.

Utilizing the extensible beams, the jacks may be positioned at locations at which they will provide a stabilizing base for the crane. The inverted jacks are lowered into contact with the ground in order to support and stabilize the carrier unit and the superstructure unit. The jacks may be lowered sufficiently, if desired, so as to support the crane in a manner such that the tires are elevated above the ground.

Load Moment Indicator (LMI) systems have been developed to monitor the load the crane is experiencing to prevent a crane from toppling. The LMI system may be as simple as an indicator or may sound an alarm if a threshold is reached. Modern monitoring systems maintain a load chart that is dependent upon a given crane model and configuration. For example a given crane may have multiple load charts based on such configurations as counterweight status and outrigger position. Because the outriggers vary in position about the crane, the threshold moment may vary depending on the boom angle.

Historically, a crane operator would determine the degree to which the outrigger beams should be extended to properly stabilize a crane, and visually inspect to determine if the jacks were lowered to a degree such that they were supporting and stabilizing the crane. It is useful, however, to be able to monitor the positions and conditions of the outrigger elements automatically and to provide an indication to the operator of the arrangement of the outriggers prior to crane operation. Furthermore, it would also be beneficial to be able to track the position of the outriggers, determine appropriate load charts, and provide this information to a crane monitoring and control system without the user having to input the information.

Historically, any calibration of a sensor is typically done through the use of test tools that are brought to the crane site and calibration is done by a maintenance technician. If a sensor goes out of calibration during normal operation, the sensor would then be inoperable until the tools were brought on site and the maintenance technician was able to calibrate the crane.

It would be beneficial for the monitoring and control system to be able to calibrate a sensor without the use of external equipment. Such a system would enable the crane to return to operation rapidly and would allow more frequent calibration of the crane sensors than would otherwise be possible.

### SUMMARY

Embodiments of the invention are directed to an outrigger monitoring system for a mobile crane system. The outrigger monitoring system includes a processing unit, a graphic display operably coupled to the processing unit, and a sensor operably coupled to the processing unit. The sensor is adapted to determine an extended length of an outrigger and output a signal representative of the extended length to the processing unit. The outrigger monitoring system further includes a data store operably coupled to the processing unit storing computer executable instructions, that when executed by said processing unit cause the processing unit to perform a series of functions. The functions include determination of crane fulcrum data dependent on the signal, storing the crane fulcrum data for use in calculation of allowable crane operation, determining an outrigger status dependent on the signal, and cause the graphic display to display a graphic representation of the outrigger status.

Another embodiment of the invention is directed to a graphical user interface system for interacting with a crane load moment safety system. The graphical user interface system includes a processing unit, a display operably coupled to the processing unit, and a data store operably coupled to the processing unit. The data store stores computer executable instructions that, when executed by the processing unit, cause the display to display graphical user interface elements. The graphical user interface elements include a graphic representation of an actual position of an outrigger and an object indicating a status of the crane load moment safety system.

Further embodiments of the invention are directed to a computer readable storage medium having instruction stored thereon that, when executed by a processing unit, implement a method. The method includes displaying a setup selector object, receiving a first user input indicating a setup selection, determining an actual extended length of the outrigger, determining if the actual extended length is within a predetermined tolerance of a valid operating position, and providing a first indicator indicating whether the actual extended length is within said predetermined tolerance of the valid operating position.

In another embodiment, a computer readable storage medium having instruction stored thereon that, when executed by a processing unit, implement a method for calibrating a length sensor of an outrigger monitoring system is disclosed. The method includes prompting a user to move an outrigger to a first position, receiving a first user input indicating that the outrigger is at the first position, receiving a first signal representative of the first position, storing a first value corresponding to the first signal, prompting the user to move the outrigger to a second position, receiving a second user input indicating that the outrigger is at the second position, receiving a second signal representative of the second position, and storing a second value corresponding to the second signal. A third position of the outrigger is then calculated based on a third signal and the stored first and second values.

### BRIEF DESCRIPTION OF THE DRAWINGS

To further clarify the above and other advantages and features of the one or more present inventions, reference to specific embodiments thereof are illustrated in the appended drawings. The drawings depict only typical embodiments and are therefore not to be considered limiting. One or more embodiments will be described and explained with additional specificity and detail through the use of the accompanying drawings in which:

FIG. 1 is a perspective view of a mobile crane for use with embodiments of the present invention.

FIG. 2 is a system diagram of an outrigger monitoring system.

FIG. 3 is an orthogonal view illustrating a user interface for the outrigger monitoring system of FIG. 2.

FIG. 4 is a close up of an outrigger status object of FIG. 3 illustrating a user interface for manual selection of an outrigger position.

FIG. 5 is a front view of the display of FIG. 2 further illustrating the user interface of FIG. 3 for the outrigger monitoring system.

FIG. 6 is a close up view of the outrigger position monitoring object and an outrigger status object of FIG. 3.

FIG. 7 is another dose up view of the outrigger position monitoring object and an outrigger status object of FIG. 3.

FIG. 8 is another close up view of the outrigger position monitoring object and an outrigger status object of FIG. 3.

FIG. 9 is another close up view of the outrigger position monitoring object and an outrigger status object of FIG. 3.

FIG. 10 is another close up view of the outrigger position monitoring object and an outrigger status object of FIG. 3.

FIG. 11 is another close up view of the outrigger position monitoring object and an outrigger status object of FIG. 3.

FIG. 12 is another close up view of the outrigger position monitoring object and an outrigger status object of FIG. 3.

FIG. 13 is another close up view of the outrigger position monitoring object and an outrigger status object of FIG. 3.

FIG. 14 is a close up view of the outrigger status object of FIG. 3 during a calibration procedure.

FIG. 15 is another dose up view of the outrigger position monitoring object of FIG. 3 during a calibration procedure.

FIG. 16 is another close up view of the outrigger position monitoring object of FIG. 3 during a calibration procedure.

FIG. 17 is another close up view of the outrigger position monitoring object of FIG. 3 during a calibration procedure.

The drawings are not necessarily to scale.

### DETAILED DESCRIPTION

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Embodiments of the invention include systems and methods for monitoring a status of a crane outrigger. The systems and methods are applicable to a single outrigger or to a system of outriggers. The system and methods provide for a safe crane operating environment and reduce the incidence of operator error.

Throughout this application, the term “operably coupled” is defined as a connection of one or more components in a manner that allows them to function together. For example, networked computers are operably coupled through their network adapters. A display is operably coupled to a processor when the processor is able to cause the display to display an image. When components communicate through a wireless connection, they are considered to be operably coupled.

Throughout this application, reference will be made to a load chart. A load chart is defined as a set of data that describes a safe operating capacity of a crane as a function of at least one crane variable. For example, the load chart may be a capacity as a function of a boom angle, a boom extended length, a swept area, a counterweight configuration, and/or combinations of the preceding. Multiple load charts may be used to describe a crane and a load chart may be selected corresponding to a particular crane configuration. For example, three different load charts may be present in a crane having three valid operating positions for its outriggers. If the same crane then had three different counterweight configurations, there could be a total of nine different load charts for the crane. The load charts may be separate sets of data, or may be combined into a single set of data.

While currently it is common to determine load charts for a given crane and then supply those load charts to a crane operator, it is also possible that load charts may be calculated in real time if all the relevant information is provided to a processor. The phrase “calculate a load chart” means to either calculate a load chart in real time or select a preexisting load chart.

Throughout this application, reference will be made to crane fulcrum data. Crane fulcrum data is information describing the fulcrum point of a crane. The fulcrum point of the crane is the point about which the crane would pivot if the crane capacity were exceeded. In a mobile crane having extended outriggers, the fulcrum point would be the end of the outrigger facing a load.

Throughout this application reference will be made to an outrigger status. An outrigger status is defined as the state of an outrigger with respect to the outrigger's position. For example, an outrigger status may be not in a valid operating position, in a valid operating position, and in a particular valid operating position. Valid operating positions are typically positions prescribed by the crane manufacturer as positions in which the crane is intended to be operated. The phrases “actual position” and “actual extended length” refer to outrigger positions and outrigger extended lengths as determined by a sensor associated with the outrigger that is designed to provide a signal representative of the actual outrigger position or actual outrigger extended length.

Throughout this application, reference will be made to an object. An object is defined for purposes of this application as a user interface element that may display information and/or receive a user input. For example, an icon, a selection box, a button, an informative graphic, a menu, and an indicator would all be considered objects.

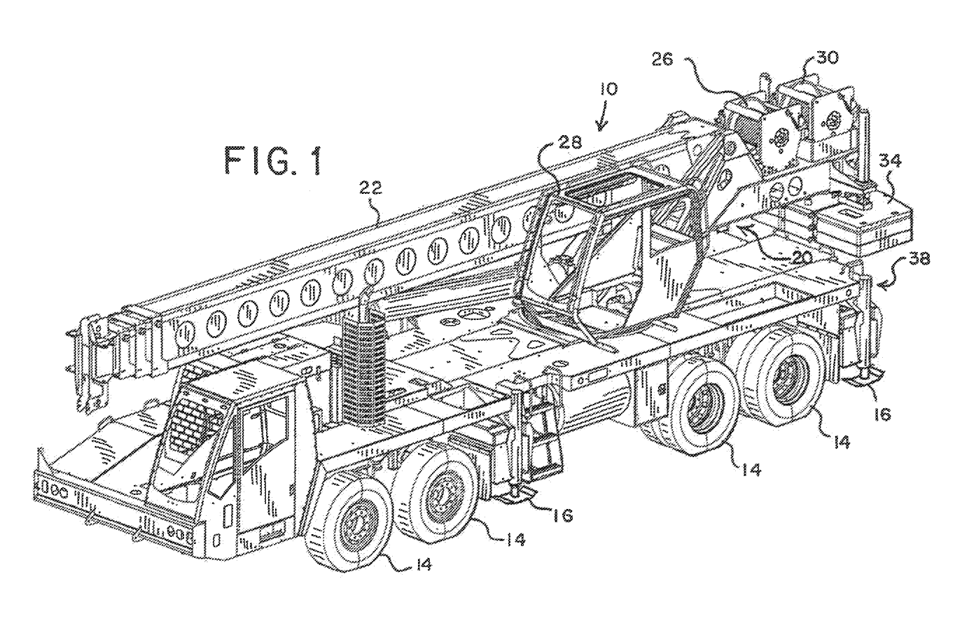

Referring to FIG. 1, an exemplary mobile crane 10 comprises a superstructure 20 rotatably disposed on a transportable chassis or carrier unit 38. The superstructure unit may include any of a variety of types of extendable booms (e.g., telescopic boom 22), as well as an operator cab 28, hoist winches 26 and 30, a counterweight assembly 34 and other conventional mobile crane components. The carrier unit 38 is provided with tires 14 that enable the mobile crane to maneuver over land to a desired location for lifting tasks.

However, once the crane 10 is positioned at a location to perform lifting tasks, as tires often do not provide adequate support for lifting loads, an outrigger system is provided for stabilizing the crane 10 during lifting operations. The outrigger system is most often provided as part of the carrier unit 38. In the example illustrated in FIG. 1 the crane 10 comprises a front and rear set of outriggers 16. In some cases, outrigger beams can be transported separately from the carrier unit and attached to the crane at the job site. Appropriate controls for the outriggers are normally provided on the carrier unit for operation by an individual standing near the crane, in the operator's cab 28, or both.

The mobile crane 10 has two sets of extendable outriggers 16, but only the left hand set of outriggers 16 are visible in the FIG. 1. The right hand set of outriggers is obstructed from view by the mobile crane. The extendable outriggers 16 may be in a retracted position as shown in FIG. 1, in which they do not extend from the mobile crane 10, in a fully extended position not shown in FIG. 1, or in a position between the fully extended and retracted positions. While the extendable outriggers 16 may be in any position between the fully extended and fully retracted positions, there are generally discrete positions to which an operator moves the outriggers 16. For example, the outriggers 16 may be extended to a third position between the fully extended and fully refracted position. It is desirable for the outriggers to have a limited number of operating positions. Because each outrigger position has at least one associated load chart, a limited number of operating positions reduces the number of load charts required.

Each outrigger position has a predetermined tolerance in which the outrigger is considered to be valid at that position. Once the outrigger moves out of that position it is considered to be in an invalid operating position. The predetermined tolerance is typically set at the factory, but it may be adjustable. In some embodiments the predetermined tolerance is a fixed value, such as two inches, whereas in other embodiments the predetermined tolerance is proportional to the extended length of the outrigger, such as three percent of the extended length.

Each outrigger may have a jack that extends vertically downward from the outrigger. The jacks are able to compensate for variation in the terrain in which the crane is operating and to level the crane. In some embodiments, the mobile crane includes sensors to monitor if the jacks are deployed and a level to ensure that the crane is level. One example of a sensor for monitoring the jacks is a pressure sensor that determines the weight on a jack. In operation, the mobile crane is often supported entirely on the jacks.

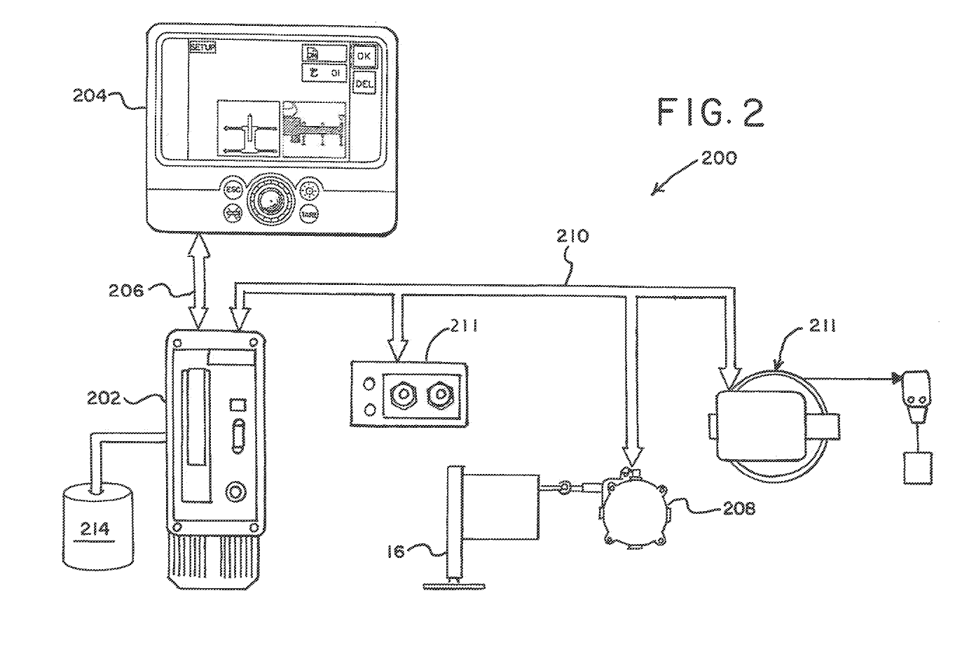

FIG. 2 illustrates an embodiment of outrigger monitoring system 200. The outrigger monitoring system 200 includes a processing unit 202 and a graphics display 204 operably coupled to the processing unit 202. In the embodiment of FIG. 2 the processing unit 202 and the graphics display 204 are shown as separate physical units, but in some embodiments they are a single physical unit. The processing unit 202 is operably coupled to the graphics display 204 through a graphic interface 206, such as a Video Graphics Array (VGA) connector, a serial connection, a Digital Video Interface (DVI), a wireless data connection, or any other connector capable of transferring display information from the processing unit 202 to the graphics display 204. The display information may be transferred directly, or in some embodiments may have at least one other device between the processing unit 202 and the graphics display 204. The graphic display of FIG. 2 is a liquid crystal display (LCD) but other display types are possible, such as organic light-emitting diodes (PLED), projection, cathode ray tube (CRT), heads up display (HUD), plasma, electronic ink, and other displays.

The outrigger monitoring system 200 further includes a length sensor 208 operably coupled to the processing unit 202. In the embodiment of FIG. 2 the length sensor 208 is operably coupled to the processing unit 202 through a bus 210. The length sensor 208 is adapted to measure the extended length of an outrigger 16. Generally there is at least one length sensor 208 for each outrigger 16, although for clarity a single length sensor 208 is shown in FIG. 2. One of skill in the art would recognize that different sensor types exist for determining the extended length of the outrigger 16. One example of a length sensor 208 for use with the current embodiment is a string potentiometer. Any type of sensor capable of measuring the extended length of the outrigger 16 can be used as long as it transmits a signal representative of the extended length to the processing unit 202. One example of sensor compatible with the claimed embodiments is disclosed in U.S. patent application Ser. No. 13/100,758. The length sensor 208 can be an analog sensor and transmit an analog signal, the analog signal can be converted to a digital signal prior to transmission, the signal can be a digital signal, or the signal could be a digital signal converted to an analog signal prior to transmission. Other sensors 211 are operably coupled to the processing unit 202 and serve other functions such as monitoring the boom. The other sensors 211 provide the processing unit 202 with other signals representative of other information such as a boom length or counterweight configuration.

The processing unit 202 can be operably coupled directly to the length sensor 208 as shown in FIG. 2, or in some embodiments, various components may be between the processing unit 202 and the length sensor 208. The length sensor 208 and the processing unit 202 are considered to be operably coupled so long as the length sensor 208 is able to provide the processing unit 202 with the signal representative of the extended length of the outrigger 16.

A data store 214 is operably coupled to the processing unit 202 and stores computer executable instructions for execution by the processing unit 202. The computer instructions cause the processing unit 202 to perform a series of functions that will be described in more detail later. Briefly, the computer executable instruction cause the processing unit 202 to determine a crane fulcrum data dependent on a signal from the length sensor 20$, determine an outrigger status dependent on the signal from the length sensor 208, and cause the graphics display 204 to display a graphic representation of the outrigger status.

In some embodiments, the processing unit 202 calculates a load chart based on the crane fulcrum data. In other embodiments, a plurality of mobile crane load charts are stored in the data store 214 and the processing unit 202 selects an appropriate load chart based on the crane fulcrum data. For example, if the data store 214 has three load charts based on three different outrigger locations, the processing unit 202 would select a load chart that is valid for a current outrigger location.

In some embodiments, the load chart calculation may be dependent upon additional information. The additional information may be a user input, or may be information from at least one other sensor. For example, the load chart might change if the user input a different value for a counterweight or if a sensor determined a different boom length.

In embodiments where more than one outrigger 16 is being monitored, the outrigger monitoring system 200 may determine the crane fulcrum data dependent upon a plurality of outrigger locations. In one embodiment, a conservative approach is used wherein the outrigger jack closest to the superstructure is used for determining the crane fulcrum data. In other embodiments the outrigger monitoring system 200 may use the average position of the outrigger jacks, the closest outrigger jack position on the working side of the crane, or other technique for determining an appropriate load crane fulcrum data.

In some embodiments, the computer executable instructions cause the processing unit 202 to store data representing the signal from the length sensor 208. The data may be stored to the same data store 214 storing the computer executable instruction, or in some embodiments may be stored to a different data store (not shown). The data store 214 is external to the processing unit 202 in the embodiment of FIG. 2, but in other embodiments the data store 214 is integrated into the processing unit 202 or it may be a remote data store physically distant from the mobile crane.

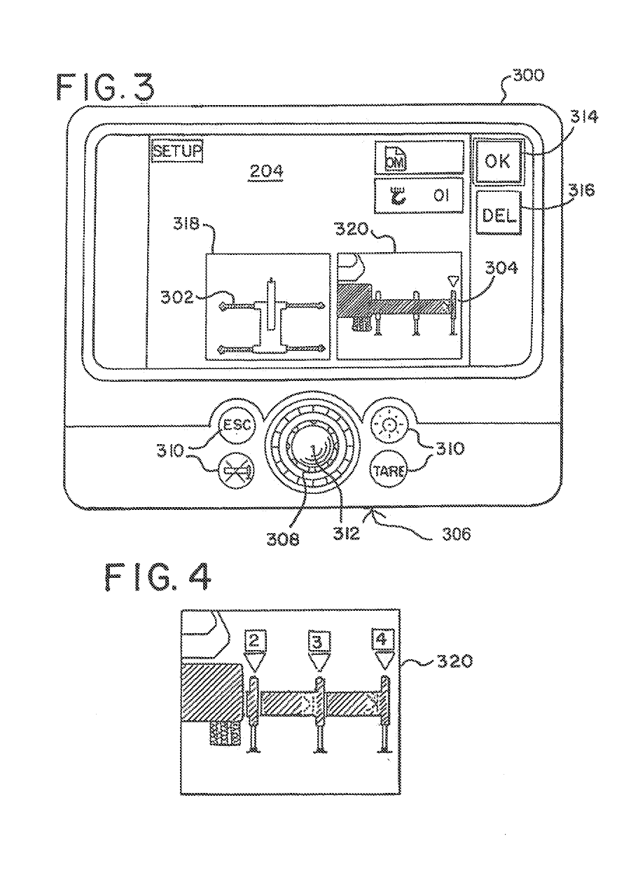

The outrigger monitoring system 200 includes a user interface system 300 for interacting with a mobile crane load moment safety system. The user interface system 300 is described in relation to FIGS. 3 through 6. The user interface system 300 is implemented on the outrigger monitoring system 200 described previously and includes the processing unit 202, the graphic display 204, and the data store 214.

Referring now to FIG. 3, the data store 214 stores computer executable instructions that, when executed by the processing unit 202, cause the graphics display 204 to show a graphic representation 302 of the extended length of an outrigger 16 and an indication of a status of an outrigger. For example, in FIG. 3 an outrigger position monitoring object 318 gives a graphic representation 302 of the extended length of four separate outriggers 16 and an outrigger status object 320 indicates a status of the mobile crane load moment safety system through graphic 304.

The user interface system 300 of FIG. 3 is used only for illustrative purposes and one of skill in the art would recognize that other user interface systems configurations and types are possible. The user interface system 300 includes the graphics display 204 showing information and an input device 306. The input device 306 could be a touchscreen or other input device as known in the art, but in the present embodiment the input device 306 is a control stick 308 and accompanying buttons 310.

The control stick 308 is used to navigate the graphics display 204 and includes a push button 312 for selection of an object. For example, the control stick 308 can move the selection of the OK object 314 to the DEL object 316 using a downward motion. The push button 312 would then be used to activate the selected object.

The user interface system 300 may be configured to control extension or retraction of the outriggers 16, or in other embodiments, controlling the positioning of the outriggers 16 may be performed by a system external to the user interface system 300.

The user interface system 300 shown in FIG. 3 has an outrigger position monitoring object 318, an outrigger status object 320, an OK object 314, and a DEL object 316. The outrigger position monitoring object 318 shows the position of each of the outriggers 16. In FIG. 3, all of the outriggers 16 are in a fully extended position and the outrigger position monitoring object 318 shows the outriggers 16 as fully extended. The outrigger status object 320 indicates that all of the outriggers 16 are in a valid position. The operator can use the control stick 308 and push button 312 to select either the OK object 314 to continue, or the DEL, object 316 to cancel. The user interface system 300 may include a setup selector object. The setup selector object receives a user input indicating that the user desires to setup the crane. In some embodiments the OK object 314 may be considered to be a setup selection object as selection of the OK object 314 steps the user into the set up process. The OK object 314 is also a continuation selector when selection of the OK object continues a process.

If the operator selects the DEL object 316, the operator is indicating that the outrigger monitoring system 200 is being overridden. In that situation, the outrigger status object 320 displays the image of FIG. 4. FIG. 4 is a manual selector of an outrigger position. It is the responsibility of the operator at this stage to select an outrigger position that corresponds to the actual outrigger position. In some embodiments, an event recorder, which may be included in the processing unit, will then log the operator override and/or the measured outrigger extended length to the data store 214. The operator uses the control stick 308 and push button 312 to select the outrigger position and then selects the OK object 314. Preferably the event recorder will also record the position selected by the operator, along with the fact that an override occurred and the signal from the sensor representing the extended length as detected by the sensor.

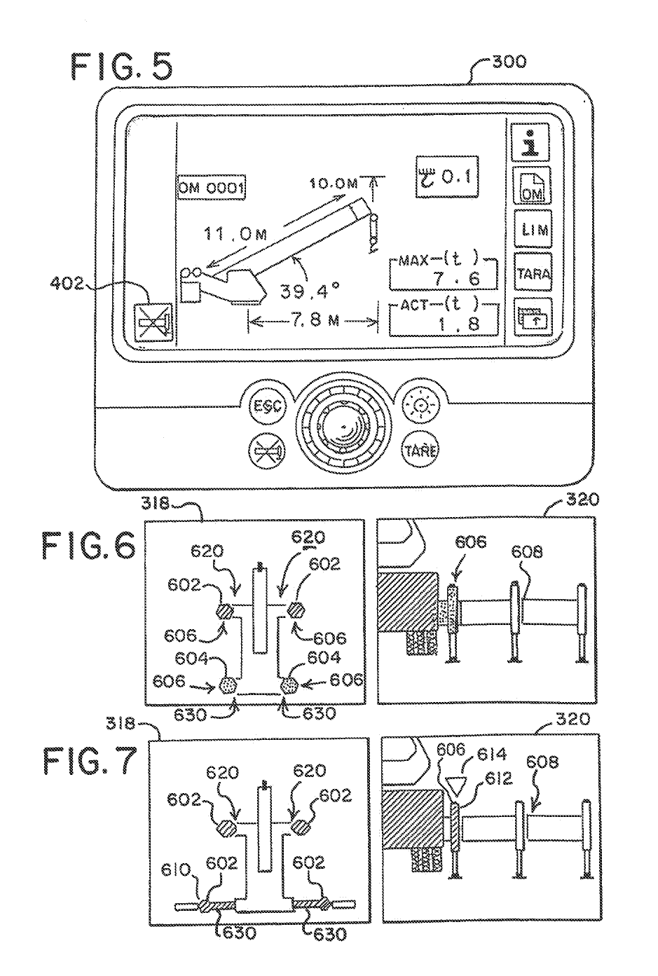

FIG. 5 illustrates the graphics display 204 after the operator has selected a manual override. An icon 402 indicates that the outrigger monitoring system 200 has been overridden.

FIGS. 6 through 13 illustrate various states of the outrigger position monitoring object 318 and the outrigger status object 320. In the embodiment of FIGS. 6 through 13 four outriggers 16 are shown on the outrigger position monitoring object 318. Each outrigger has three possible valid operating positions. When an outrigger 16 is in a valid operating position, a shaded hexagon 602 indicates that the operating position is valid. When an outrigger 16 is not in a valid operating position, a lighter hexagon 604 is displayed at the last known valid operating position. Thus the position of each outrigger 16 may be determined by viewing the outrigger position monitoring object 318. Other means of indicating a valid operating position are possible, such as using colors on the display, indicator lights, or other means.

In some embodiments, the outrigger positioning object 318 will display a linear representation of the length of the outrigger, as opposed to the discrete positions described previously. For example, the lighter hexagon 604 may move to locations other than the valid operating positions to indicate positions between valid operating positions.

The outrigger status object 320 generally indicates the outrigger position that will be used to determine the crane fulcrum data. The outrigger status object 320 displays a number of valid operating positions used in determining the crane fulcrum data. As will be described in more detail below, the outrigger status object 320 will display an operating position dependent upon all of the outriggers 16 being monitored. Furthermore, the outrigger status object 320 will display an indication when a valid operating position is being used and the operator may continue, or when a valid operating position is not in use.

FIG. 6 illustrates the outrigger position monitoring object 318 and the outrigger status object 320 when the outriggers 620, 630 are in a partially retracted state. The front outriggers 620 are positioned in a first valid operating position 606 and they have a corresponding shaded hexagon 602 indicating the valid operating position 606. The rear outriggers 630 are near the valid operating position 606 as shown by the lighter hexagon 604, but are not within the defined predetermined tolerance. The outrigger position monitoring object 318 may indicate the invalidity of the rear outrigger position by other means, such as a different color or flashing.

The outrigger status object 320 indicates that the outriggers 16 are near the first position 606, but are not in a valid configuration. The outrigger status object 320 indicates the first valid operating position 606 by shading a status outrigger 608 up to the first position 606. However, not all of the outriggers 620, 630 are in a valid operating position, so no further indication is given. Additionally, the user interface system 300 does not allow the user to continue, since at least one of the outrigger positions is not valid. The user interface system 300 may skip the OK object 314 so it is unable to be selected, it may remove the OK object 314, or it may gray out the OK object 314. In any event the result is that the user is unable to continue. The user may select the DEL object 316, which returns the user to the manual override mode of FIG. 4.

FIG. 7 illustrates the outrigger position monitoring object 318 and the outrigger status Object 320 when the forward outriggers 620 are in a retracted state at the first operating position 606 and the rear outriggers 630 are in a partially extended state at a second operating position 610. In this example, all of the outriggers 620, 630 are in a valid operating state, as indicated by the shaded hexagons 602. However, the outrigger status object 320 indicates the first operating position 606 as being the status of the outriggers 620, 630. The user is allowed to continue, but the mobile crane is treated as if all of the outriggers 620, 630 were in the first operating position. The shading of the innermost jack 612 on the outrigger status object 320 indicates that at least one outrigger 16 is at that position. Generally, the outrigger status object 320 indicates the outrigger 16 closest to the crane. If all of the outriggers 620, 630 are in a valid position, the outrigger status object 320 will display a marker 614 indicating the operating position the outrigger monitoring system 200 will use in determining a crane load fulcrum data.

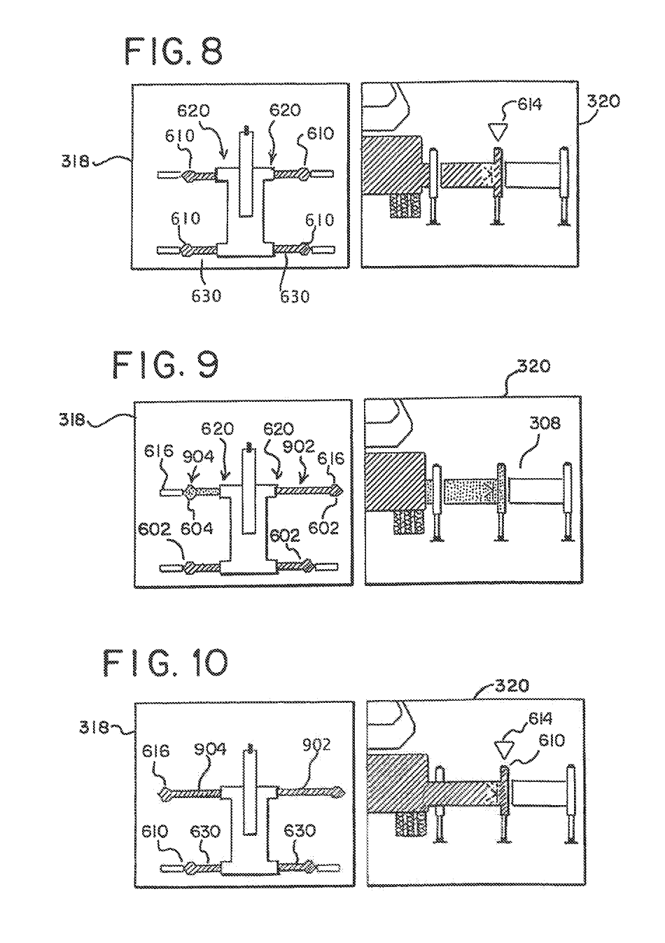

FIG. 8 illustrates the outrigger position monitoring object 318 with all four outriggers 620, 630 in the second position 610. The marker 614 appears over the second position 610 in the outrigger status object 320, indicating that each of the outriggers 620, 630 are in a valid operating position and the second position 610 is used to determine the crane fulcrum data.

FIG. 9 is an illustration where the front outriggers 16 have been moved from the position of FIG. 8 to a third position 616. In this example, the front left outrigger 904 failed to move to the third position 616. The outrigger position monitoring object 318 indicates that the front right outrigger 902 has extended to the third position 616 and is within the predetermined tolerance, as indicated by the shaded hexagon 602. The front left outrigger 904 is not in a valid operating position as shown by the lighter hexagon 604. Because at least one outrigger 16 is not in a valid operating position, the user is unable to continue. The user will either need to move the front left outrigger 904 to a valid operating position or do a manual override of the outrigger monitoring system 200. The operating status object 320 indicates that the outriggers 16 are not in a valid configuration by changing the shading on the status outrigger 308.

FIG. 10 is similar to FIG. 9, with the exception that the front left outrigger 904 has moved into the third position 616. The outrigger position monitoring object 318 indicates that the front two outriggers 902, 904 are fully extended and in a valid position. The rear outriggers 630 remain in the second position 610 and are in a valid position. The outrigger status object 320 remains at the second position 610, despite the front outriggers 902, 904 extending past the second position 610. Furthermore, since all the outriggers 16 are in a valid position, the marker 614 is displayed at the second position 610 indicating that the second position 610 will be used to determine the crane fulcrum data. The OK object 314 is active and user can advance through the setup.

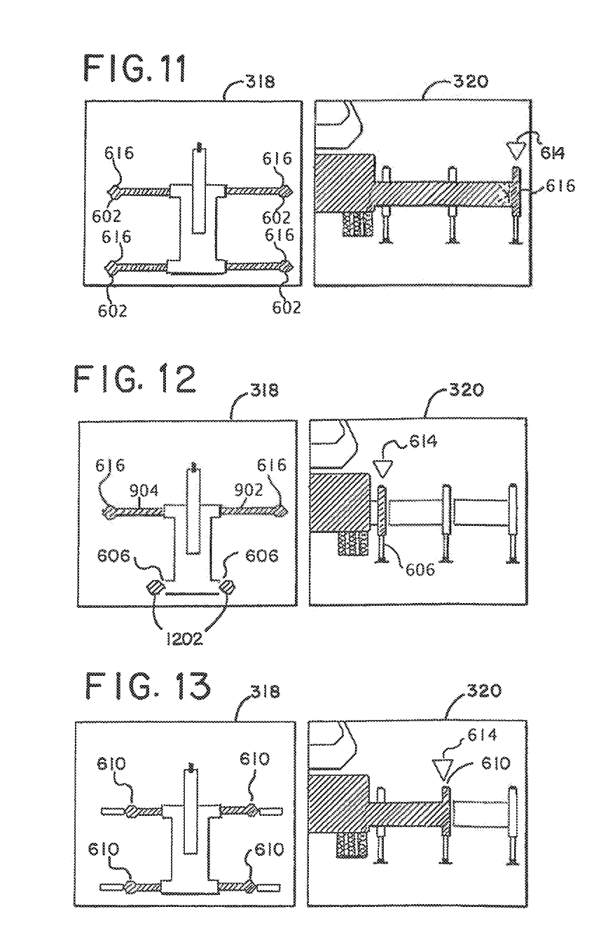

FIG. 11 illustrates all of the outriggers 16 in the third position 616. Each of the outriggers 16 is in a valid position, as indicated by the shaded hexagons 602 of the outrigger position monitor object 318. Because each outrigger 16 is in the third position 616, the outrigger status object 320 is shaded out to the third position 616 and includes the marker 614 indicating which position will be used to determine the crane fulcrum data.

FIG. 12 illustrates the rear outriggers 1202 being returned to the first position 606 and the front outriggers 902, 904 being fully extended in the third position 616. In this configuration, the outrigger status monitor 320 indicates that the first position 606 will be used for crane fulcrum data determination and the marker 614 indicates that all of the outriggers 16 are in a valid position.

FIG. 13 illustrates all of the outriggers 16 having been moved to the second position 610. Since all of the outriggers 16 are in the second position 610 and are valid as indicated by the outrigger position monitoring object 318, the outrigger status monitor 320 indicates that the outriggers 16 are in at least the second position 610 by shading the status outrigger up to the second position 610. The marker 614 indicates that all of the outriggers 16 are in a valid position and the second position 610 is used for all load chart determinations.

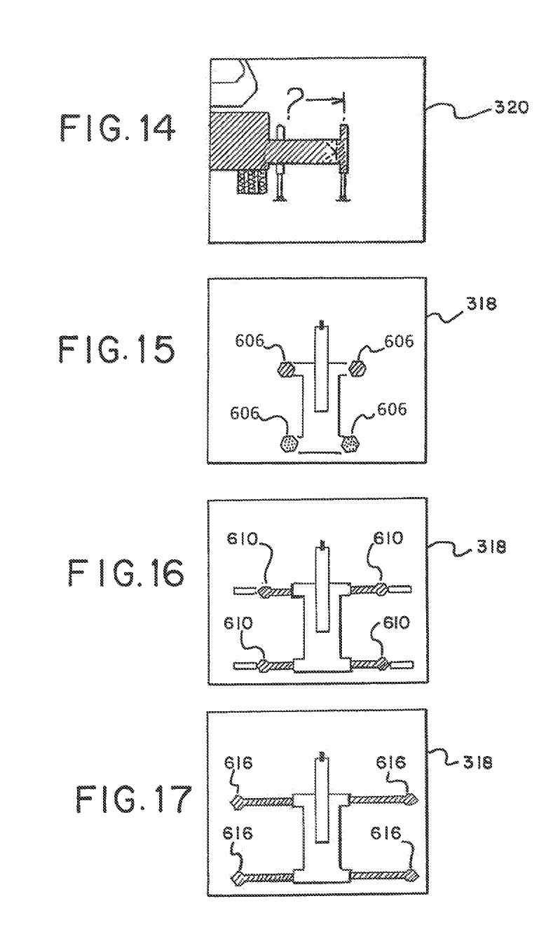

The length sensors 208 can be calibrated using the outrigger monitoring system 200. In some embodiments, a calibration menu is locked for a normal user and requires unlocking for calibration. For example, a service code may need to be entered to calibrate the length sensors 208, in the embodiment of FIG. 14, the outrigger status object 320 indicates that user is calibrating the outriggers 16. If the user selects the OK object 314, the calibration begins.

The calibration can be performed for each outrigger independently, or in some embodiments, the outriggers can be calibrated as a group. When the outriggers are calculated independently, a single outrigger is moved.

As shown in FIG. 15, the user initially fully retracts the outriggers 16 to a first known position. The calibration screen may prompt the user to retract the outriggers 16 or the processing unit may activate a mechanism to move the outriggers 16. Once the outriggers 16 are fully retracted to the known first position 606 as shown on the outrigger position monitoring object 318, the user “zeros” the length sensor 208 indicating the outriggers 16 are fully retracted. The processing unit 202 saves a first value of a first signal sent by the length sensor 208.

If the sensors are being calibrated as a group, the user will fully retract all of the outriggers. The calibration screen may prompt the user to retract all of the outriggers. In some embodiments the calibration screen may give the user the option to calibrate all of the sensors as a group or individually. The calibration will continue to be described in relation to a single sensor, but embodiments of the invention are not so limited and it will be understood that the procedure described can be performed in a group.

As shown in FIG. 16, the user extends the outriggers 16 to an intermediate known second position such as the second valid operating position 610, typically 50% of the maximum extended length. The user then indicates that the outriggers 16 are at the known second position and the processing unit 202 saves a second value of the signal sent by the length sensor 208.

In embodiments where only a rough calibration is required, the two stored values can be used to calculate a subsequent position of the extended length of the outrigger assuming a linear sensor output. Such a calculation is well known in the art and would typically be automatically done by the processing unit 202.

For a more accurate calibration, a greater number of calibration positions can be used. As shown in FIG. 17, the user can extend the outriggers 16 to a known third position 616. The user indicates that the outriggers 16 are at the third position and saves a third value of the signal sent by the length sensor 208. The processing unit 202 now has access to three different values corresponding to known locations of the outriggers 16 and can interpolate a subsequent position of the outriggers 16 based on a signal from the length sensor 208 at the subsequent position. Again, one of ordinary skill in the art would be able to readily determine the position of the outrigger based on the three stored values and the subsequent signal from the length sensor.

While the values and positions described above are given a numerical reference, the values and measurements do not need to be performed in numerical order. Thus the outriggers do not have to be at the known first position 606 initially and do not need to end at the known third position 616.

The above calibration procedure was described in the context of the outrigger length sensors, but the calibration procedure is applicable to other crane safety monitoring sensors such as a boom angle, slew angle, and boom length sensor. Generally, the component is moved to three different known locations with the value recorded at each location by the crane monitoring system. The position of any component can then be calculated given a signal from a sensor.

In some embodiments it may be desirable for the predetermined tolerance to adjustable at this point in time. Typically the user will have an option to adjust the predetermined tolerance and will input a value. This step is completely optional and may be locked with a service code different from that of the calibration procedure.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. An outrigger monitoring system, comprising:
a) a processing unit;
b) a graphic display operably coupled to said processing unit;
c) a sensor operably coupled to said processing unit and adapted to:
i) determine an extended length of an outrigger; and
ii) output a signal representative of said extended length to said processing unit; and
d) a data store operably coupled to said processing unit storing computer executable instructions, that when executed by said processing unit cause said processing unit to:
i) determine crane fulcrum data dependent on said signal;
ii) store said crane fulcrum data for use in calculation of allowable crane operations;
iii) determine an outrigger status dependent on said signal; and
iv) cause said graphic display to display a graphic representation of said outrigger status, wherein said outrigger status indicates whether the outrigger is in a valid operating position.

2. The outrigger monitoring system of claim 1 wherein said computer executable instructions further cause said processing unit to store data representing said signal.

3. The outrigger monitoring system of claim 1 wherein said computer executable instructions further cause said processing unit to cause said graphic display to display a graphic representation of said extended length.

4. The outrigger monitoring system of claim 1 further comprising:
a) at least one other sensor operably coupled to said processing unit and adapted to:
i) determine at least one other extended length of at least one other outrigger; and
ii) output at least one other signal representative of said at least one other extended length to said processing unit; and
b) wherein said processing unit's determination of said crane fulcrum data is further dependent on said at least one other signal.

5. The outrigger monitoring system of claim 1 wherein said computer executable instructions further cause said processing unit to select a load chart dependent on said fulcrum data.

6. The outrigger monitoring system of claim 1 wherein said computer executable instructions further cause said processing unit to calculate a load chart dependent on said crane fulcrum data.

7. The outrigger monitoring system of claim 6 further comprising a second sensor operably coupled to said processing unit and adapted to determine an extended boom length and output a second signal representative of said boom length to said processing unit, wherein said processing unit's calculation of said load chart is further dependent upon said second signal.

8. The outrigger monitoring system of claim 6 further comprising an additional sensor operably coupled to said processing unit and adapted to determine a counter weight configuration and output an additional signal representative of said counterweight configuration, wherein said processing unit's calculation of said load chart is further dependent upon said second signal.

9. A graphical user interface system for interacting with a crane load moment safety system, the graphical user interface system comprising:
a) a processing unit;
b) a display operably coupled to said processing unit; and
c) a data store operably coupled to said processing unit, said data store storing computer executable instructions that, when executed by said processing unit, cause said display to display;
i) a graphic representation of an actual position of an outrigger;
ii) a status object indicating a status of said crane load moment safety system; and
iii) a continuation object selector when said status object indicates a valid operating position.

10. The graphical user interface system of claim 9 wherein said computer executable instructions further cause said processing unit to determine a crane load chart dependent on said status of said crane load moment safety system, and cause said display to display an object representing said crane load chart.

11. The graphical user interface system of claim 9 wherein said object indicates a valid outrigger configuration when the outrigger is in a valid operating position.

12. The graphical user interface system of claim 9 wherein said object indicates an invalid outrigger configuration when the outrigger is not in a valid operating position.

13. The graphical user interface system of claim 9 wherein said graphic representation of an actual outrigger position is a graphic representation of an outrigger with an extension proportional to an actual outrigger extended length.

14. A computer readable storage medium having instruction stored thereon that, when executed by a processing unit, implement a method, the method comprising:
a) displaying a setup selector object;
b) receiving a first user input indicating a setup selection;
c) determining an actual extended length of an outrigger;
d) determining if said actual extended length is within a predetermined tolerance of a valid operating position; and
e) providing a first indicator indicating whether said actual extended length is within said predetermined tolerance of said valid operating position.

15. The computer readable storage medium of claim 14 wherein said method further comprises:
determining crane fulcrum data dependent upon said actual extended length when said actual extended length is within said predetermined tolerance of said valid operating position.

16. The computer readable storage medium of claim 14 wherein said method further comprises:
storing data corresponding to said actual extended length to a data store.

17. The computer readable storage medium of claim 14 wherein said method further comprises:
i) receiving a second user input corresponding to a user override;
ii) displaying an operating mode selector in response to receipt of said second user input;
iii) receiving a third user input corresponding to a selected manual operating mode; and
iv) storing data corresponding to said selected manual operating mode and the extended length as detected by the sensor to the data store.

18. The computer readable storage medium of claim 14 wherein said method further comprises:
i) determining that said actual extended length has deviated from within said predetermined tolerance to outside said predetermined tolerance;
ii) providing a second indicator indicating that said actual extended length is outside said predetermined tolerance; and
iii) storing data representative of said second indicator and said actual extended length.

19. The computer readable storage medium of claim 14 wherein said predetermined tolerance is stored on said computer readable storage medium.

20. The computer readably storage medium of claim 14 wherein said predetermined tolerance is plus or minus two inches.

21. The computer readable storage medium of claim 14 wherein said predetermined tolerance is plus or minus three percent of a selected length.

22. The computer readable storage medium of claim 14 wherein said first indicator indicates that said actual extended length is within said predetermined tolerance and said method further comprises providing a continuation selector.

23. The computer readable storage medium of claim 1.4 wherein said first indicator indicates that said actual extended length is outside said predetermined tolerance and said method further comprises suppressing a continuation selector.

24. The computer readable storage medium of claim 14 wherein said method further comprises:
i) determining at least one other actual extended length of at least one other outrigger;
ii) determining if said at least one other actual extended length is within said predetermined tolerance of a second valid operating position;
iii) providing a second indicator indicating whether each of the at least one other actual extended length is within said predetermined tolerance of said second valid operating position.

25. The computer readable storage medium of claim 25 wherein said method further comprises:
in response to each of said actual extended length and at least one other actual extended length being within said predetermined tolerance of at least one valid operating position, determining crane fulcrum data dependent upon a minimum actual extended length from among said actual extended length and at least one other actual extended length.

26. A computer readable storage medium having instruction stored thereon that, when executed by a processing unit, implements a method for calibrating a sensor of a crane monitoring system using a graphical user interface of the crane monitoring system, the method comprising:
a) causing a component to move to a known first position;
b) receiving a first user input through said graphical user interface indicating that the component is at said known first position;
c) receiving a first signal from a sensor representative of said first position;
d) storing a first value corresponding to said first signal;
e) causing said component to move to a known second position;
f) receiving a second user input through said graphical user interface indicating that said component is at said known second position;
g) receiving a second signal from a sensor representative of said known second position; and
h) storing a second value corresponding to said second signal, thereby creating a calibrated sensor.

27. The computer readable storage medium of claim 26 wherein said method further comprises:
i) causing said component to move to a third position;
ii) receiving a third user input through said user interface indicating that said component is at said third position;
iii) receiving a third signal representative of said third position;
iv) storing a third value corresponding to said third signal; and
v) wherein said calculation of said calibrated position is further based on said third stored value.

28. The computer readable storage medium of claim 26 wherein causing said component to move includes prompting a user to manually move said component.

29. The computer readable storage medium of claim 26 wherein causing said component to move includes the processing unit actuating a mechanism to move the component.

30. The computer readable storage medium of claim 26 wherein said component is a crane outrigger.

31. The computer readable storage medium of claim 26 wherein the calibrated sensor is subsequently used to display a subsequent position of the component, wherein the executed instructions
a) calculate a subsequent position of said component based on a subsequent signal and
b) display an object in said graphical user interface representative of said subsequent position.
